(19) United States
(12) Patent Application Publication
(10) Pub. No.: US 2023/0215311 A1
(43) Pub. Date: Jul. 6, 2023

(54) AUTOMATIC USER INTERFACE RECONFIGURATION BASED ON EXTERNAL CAPTURE

(71) Applicant: International Business Machines Corporation, Armonk, NY (US)

(72) Inventors: Hemant Kumar Sivaswamy, Pune (IN); Vijay Ekambaram, Chennai (IN); Sarbajit K. Rakshit, Kolkata (IN)

(21) Appl. No.: 17/646,877

(22) Filed: Jan. 4, 2022

(51) Int. Cl. G09G 3/00; G06F 40/143; G06V 30/12

(52) U.S. Cl. CPC G09G 3/03; G06F 40/143; G06V 30/133; G09G 2340/14; G09G 2320/0626; G09G 2340/045; G09G 2354/00; G09G 2340/0492; G06V 2201/02

(57) ABSTRACT

A method to automatically adjust a user interface of a mobile device for readability is provided. A processor retrieves an external capture of a display of a mobile device. A processor converts text in the external capture to a computer readable format. A processor determines a readability index of the external capture based on a comparison of the text in the external capture to user interface data of the mobile device. A processor, in response to the readability index being below a threshold value, adjusts at least one display parameter of a user interface of the mobile device.

### BACKGROUND OF THE INVENTION

The present invention relates generally to the field of user interfaces, and more particularly to reconfiguring a user interface on a mobile device display based on a capture of the display from an external device.

Mobile devices can very greatly in size, shape, and form. With foldable and curved displays becoming more common, software developers must account for an exceedingly large group of different displays and other factors. User interfaces or entire operating systems must be changed manually to account for these variances.

### SUMMARY

Embodiments of the present invention provide a method to automatically adjust a user interface of a mobile device for readability. A processor retrieves an external capture of a display of a mobile device. A processor converts text in the external capture to a computer readable format. A processor determines a readability index of the external capture based on a comparison of the text in the external capture to user interface data of the mobile device. A processor, in response to the readability index being below a threshold value, adjusts at least one display parameter of a user interface of the mobile device.

### BRIEF DESCRIPTION OF THE SEVERAL VIEWS OF THE DRAWINGS

FIG. 1 is a functional block diagram illustrating a networked environment, in accordance with an embodiment of the present invention.

FIG. 2 illustrates operational processes of a readability monitor, on a computing device within the environment of FIG. 1, in accordance with an embodiment of the present invention.

FIGS. 3A and 3B depict an example of adjusting a display parameter to increase readability of a zone, in accordance with an embodiment of the present invention.

FIG. 4 depicts a block diagram of components of the computing device executing a readability monitor, in accordance with an exemplary embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

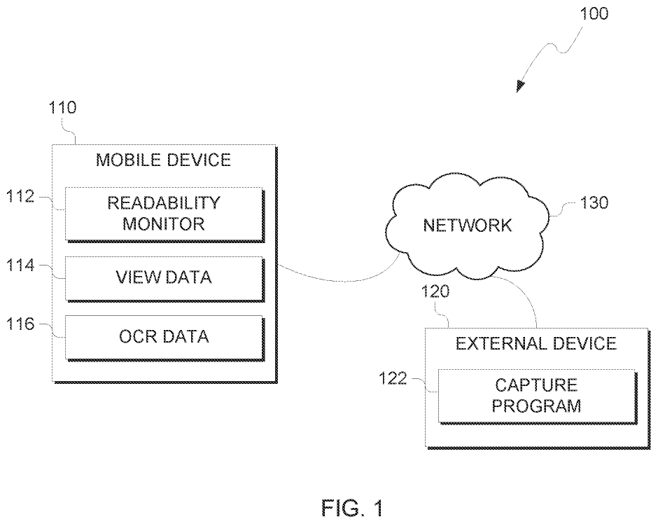

The present invention will now be described in detail with reference to the Figures. FIG. 1 is a functional block diagram illustrating networked environment, generally designated 100, in accordance with one embodiment of the present invention. PAN environment 100 includes mobile device 110 and external device 120 connected over network 130. Mobile device 110 includes readability monitor 112, view data 114, and optical character recognition (OCR) data 116. External device 120 includes capture program 122.

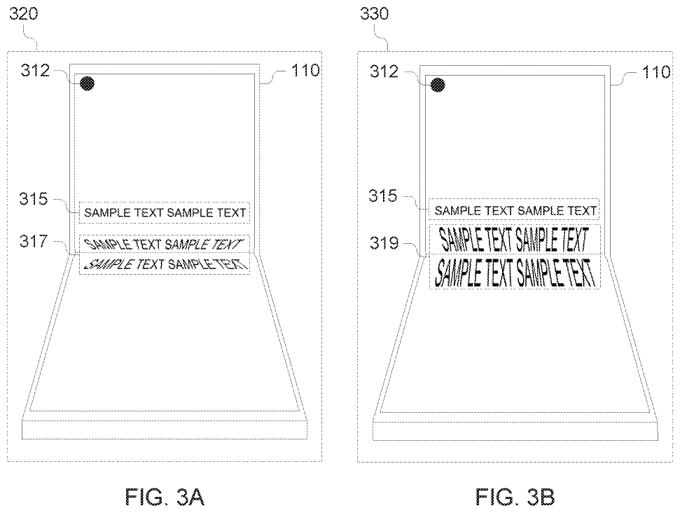

In various embodiments of the present invention, mobile device 110 and external device 120 are each a computing device that can be a standalone device, a server, a laptop computer, a tablet computer, a netbook computer, a personal computer (PC), or a desktop computer. In another embodiment, mobile device 110 or external device 120 represent a computing system utilizing clustered computers and components to act as a single pool of seamless resources. In general, mobile device 110 and external device 120 can be any computing device or a combination of devices with access to view data 114, OCR data 116 and is capable of executing readability monitor 112 and capture program 122. Mobile device 110 and external device 120 may include internal and external hardware components, as depicted and described in further detail with respect to FIG. 3.

In this exemplary embodiment, readability monitor 112, view data 114, and OCR data 116 are stored on mobile device 110; and capture program 122 is stored on external device 120. However, in other embodiments, readability monitor 112, view data 114, OCR data 116 and capture program 122 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between mobile device 110 and external device 120, in accordance with a desired embodiment of the present invention.

In various embodiments, a user is operating or utilizing mobile device 110 while also capturing the display of mobile device 110 with external device 120. External device 120 includes, or has access to, a camera or other image capturing device that is capable of recording the display of mobile device 110. In some scenarios, external device 120 is a head mounted display (HMD) (e.g., augmented reality (AR) smart glasses) which include a camera for capturing the user's view of mobile device 110. In other scenarios, external device 120 is any device with a camera that can capture the display of mobile device 110 from a perspective, or near approximate location, of a user of mobile device 110.

In various embodiments, based on external capture from external device 120 of the display of mobile device 110, embodiments of the present invention determine if a user interface (UI) displayed on mobile device 110 is readable, legible, or otherwise viewable by the user. For modern mobile devices, the form factor of each device can vary widely, making UI development difficult to adjust or account for varying display types. This issue becomes even more profound for foldable or curved displays as the viewing angles can varying greatly, as well as localized distortion that can occur from the bends, folds or curves of non-flat or movable displays. For folding phones, a crease is typically present where mobile device 110 would fold, which can distort text and images along the crease, decreasing readability. Curved edges, such as “waterfall” displays, can also distort text and images along the curves of the display. Embodiments of the present invention recognize that by monitoring the display output of mobile device 110 with external device 120, improvements to UI readability can be applied automatically based on the readability of the capture from external device 120. Furthermore, embodiments of the present invention identify various zones of the display of mobile device 110 to create location specific UI configuration changes to address readability issued caused by localized issues in the display of the mobile device 110, such as at creases in a foldable device or stretching for curved portions of the display.

In various embodiments, mobile device 110 is operated in typical fashion by a user. As the user navigates various UIs on mobile device 110, external device 122 captures an external view of the display of mobile device 110. In some embodiments, external device 122 is an HMD, such as a pair of smart glasses, with an attached camera that captures the user's view of mobile device 110. In other embodiments, external device 122 is mounted on another location of the user's person, such as a camera on the lapel of a shirt or as a necklace. In even additional embodiments, external device 122 is any image capturing capable device that has an external view of the display of mobile device 110.

In various embodiments, capture program 122 captures image data of the display of mobile device 110 and sends the images to mobile device 110 for optical character recognition (OCR) of the images of the display of mobile device 110. Readability monitor 112 of mobile device 110 converts the images of any text captured via OCR, storing the results in OCR data 116. In various embodiments, readability monitor 112 collects on-screen display information as view data 114. View data 114 indicates the various UI elements and other text components being displayed by mobile device 110 at a given time. For example, readability monitor 112 may extract an Extensible Markup Language (XML) tree regarding the display of webpage of web-enabled application to determine the various UI elements that are being displayed at a given time. In another example, readability monitor 112 directly captures a render of the UI being displayed at a given time and performs OCR on the direct-capture image of the display of mobile device 110. As discussed herein, view data 114 is any information gathered from programs executing within mobile device 110 to determine and identify the text being displayed on-screen when capture program 122 captures an image of the text being displayed on-screen, which is derived externally from mobile device 110. View data 114 may include XML view tree, as discussed herein, that are extracted from running application on mobile device 110.

In various embodiments, readability monitor 112 adjusts the captured image to improve the accuracy of the converted text in OCR data 116. In some scenarios, capture device 120 may not be pointed directly at the display of mobile device 110. In such scenarios, readability monitor 112 adjusts the captured image to account for the viewing angle. In such scenarios, readability monitor 112 skews, aligns or otherwise manipulates the captured image such that the captured image of the display matches a known dimensionality and viewing angle of mobile device 110. For a rectangular flat display, readability monitor 112 adjusts the captured image to match a known display size or ratio of the mobile device (e.g., a 6.7 inch display at a 16:10 ratio is known for the device, with readability monitor 112 adjusting the image of the display to match the known display size or ratio. For a foldable phone or other curved displays, readability monitor 112 applies the captured image to a three-dimensional model or contour map of the size and shape of the display, at the time of capture. For such phones, view data 114 also includes various data points regarding the “shape” of the phone when an image is captured. For example, for a single hinged folding phone, view data 114 also has a “folding angle” that represents the angle at which mobile device 110 was folded at the time of capture. In this example, the foldable phone's angle when completely open is 180° ranging to 0° when completely folded closed. Based on the current view data 114 that indicates the position of the display of mobile phone 110, readability monitor 112 generates a viewing plane and maps the capture image to said plane to account for changes in folding arrangements and other movable displays. In various embodiments, readability monitor 112 determines the display's location and position in the captured image based on machine vision. Readability monitor 112 includes various training images of various orientations of mobile device 110. By comparing the training images to a captured image, readability monitor 112 determines the display's location and position in the captured image.

In various embodiments, readability monitor 112 compares view data 114 of the various UI elements being displayed by mobile device 110 to a user with the OCR data 116 captured by external device 120. By comparing the two separate representations of the UI data being displayed to a user, readability monitor 112 determines a readability index of the current view of the user. If the OCR data 116 does not match aspects of the UI as represented by view data 114 by a certain threshold, then readability monitor 112 determines that the UI is not readable by the user. In various embodiments, readability monitor 112 determines the readability index based on the number of mistakes found in OCR data 116 when compared to view data 114. If the number of mistakes exceeds a threshold value, then readability monitor 112 adjusts one or more display parameter of the UI being displayed on mobile device 110 including, but not limited to, adjusting font size of the UI, adjusting a zoom factor of the UI, adjusting a brightness of the display for mobile device 110, or changing orientation of the display for mobile device 110.

In various embodiments, readability monitor 112 adjusts the display, or zone of the display, when the readability index drops below a certain threshold. In some instances, readability monitor 112 instructs the captured application or operating system (OS) to increases the font size for the entire app, or for a specific display area that corresponds to a zone with a low readability index. For example, a crease in a folding phone causes the readability index to be below the threshold. In this example, readability monitor 112 instructs the application to adjust font size in the area of the display at or surrounding the zone corresponding with the low readability (i.e., the crease). In another example, readability monitor 112 instructs the captured application or OS to apply a zoom factor. For images and other non-scalable UI elements, readability monitor 112 may increase a zoom or scaling factor for the application or OS. In another example, readability monitor 112 may insert additional UI elements to move portions of the application or OS such that a zone with low readability is avoided, or in which UI and text is not to be displayed to avoid distortion. For example, for a display with curved edges, readability monitor 112 inserts a gap or other UI element that prevents applications from rendering in the area. In another example, readability monitor 112 may adjust the brightness or contrast of the display of mobile device 110. In some scenarios, low light or other environmental factors may affect the determination of a readability index. As such, readability monitor 112 may increase brightness of the display to increase readability.

In various embodiments, readability monitor 112 determines an updated readability index after adjusting one or more display parameters of either the display of mobile device 110 of any application or part of the OS that has been observed to cause low readability. If the updated readability index is increased due to the change, then readability monitor 112 records the application or OS feature, as well as the adjustment of the one or more display parameters. If readability monitor 112 detects a similar scenario or zone is affected, readability monitor 112 applies the recorded adjustment to attempt a similar fix to the issue. For example, if a curved area always produces low readability scores, readability monitor 112 identifies an adjustment that improves the readability index and applies a similar adjustment when other applications cause the same issue. If the updated readability index is decreased due to the change, then readability monitor 112 reverts the adjustment and attempts another adjustment. Once an adjustment that increases the readability index is identified, readability monitor 112 records the application or OS feature, as well as the adjustment of the one or more display parameters that caused the increase in the readability index.

In some embodiments, readability monitor 112 separates view data 114 and OCR data 116 into one or more zones. For certain devices where readability may be difficult for a user, such as in a crease of a folding display or on a sharp curve of a curved display, readability monitor 112 determines a readability index for specific zones portion of the captured display from external device. For example, if mobile device 110 has a “waterfall” curve on the edges, then readability monitor 112 identify OCR data 116 derived from these edges of the display, ensuring these zones are within an acceptable value of the readability index.

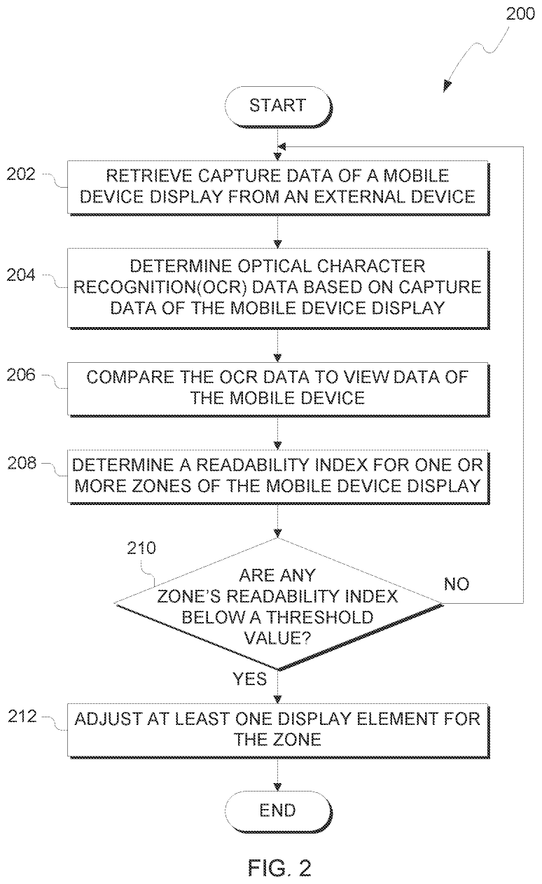

FIG. 2 illustrates operational processes, generally designated as 200, of readability monitor 112. In process 202, readability monitor 112 retrieves capture data from capture program 122 of external device 120. As discussed herein, external device 120 captures the approximate view of the display from the user's perspective. In process 204, readability monitor 112 determines OCR data 116 based on the capture data from external device 120. In process 206, readability monitor 112 compares the OCR data 116 to locally generated view data 114, which indicate the actual text and UI of the device. Based on this comparison, readability monitor 112 determines a readability index for one or more zones of the display of mobile device 110 (Process 208). For each character of text in OCR data 116 that does not match view data 114, readability monitor 112 adjusts the readability index.

In decision process 210, if the readability index for a given zone is below a threshold value (YES branch), then readability monitor 112 adjusts one or more display elements of the UI (process 212) such as, but not limited to, adjusting font size of the UI, adjusting a zoom factor of the UI, adjusting a brightness of the display for mobile device 110, or changing orientation of the display for mobile device 110. If the readability index for a given zone is above a threshold value (NO branch of decision process 210), then readability monitor 112 continues monitoring local view data 114 and external OCR data 116 to determine if any changes in the user view or changes with the UI of mobile device 110 alter the readability index past the threshold value.

FIGS. 3A and 3B depict an example of adjusting a display parameter to increase readability of a zone. FIG. 3A is a depiction of an image capture 320 of mobile device 110. As discussed herein, external device 120 includes a camera or other image capturing hardware of which capture program 122 utilizes to generate image capture 320. After being generated, capture program 122 sends image capture 320 to mobile device 110, which in turn readability monitor 112 of mobile device 110 analyzes for a readability index of text across various zones. Image capture 320 has captured text in zones 315 and 317 and anchor point 312. As discussed herein, in some embodiments, readability monitor 112 identifies mobile device 110 based on machine vision. In this example, image analysis of readability monitor 112 identifies an cutout camera 312 of mobile device 110. Other features of mobile device 110 may also be identified in image capture 320 to help identify the presence of mobile device 110 in image capture 320 as well as to determine an orientation of mobile device 110 in image capture 320. For example, an earpiece or speaker location of mobile device 110 may be identified to identify mobile device 110 as well as the position of mobile device 110 in image capture 320. In various embodiments, once mobile device 110 is identified and a position is determined, readability monitor 112 generates a three-dimensional model or contour map of the size and shape of the display in image capture 320. With the three-dimensional model or map, readability monitor 112 adjusts, skews, shifts or otherwise manipulates image capture 320 prior to applying OCR for more accurate conversion of image-to-text.

In this example, images capture 320 captures text in zones 315 and 317. Zone 315 has text captured from the flat portion of a folding display for mobile device 110. Zone 317 has text captured from a curved portion of the folding display for mobile device 110. Based on the curvature of this portion of the folding display, readability monitor 112 determines the readability index for zone 317 is below a threshold value. In response, readability monitor 112 adjusts a display parameter associated with zone 317. In this example, readability monitor 112 increases the font size of text for this zone, as depicted in adjusted zone 319 of FIG. 3B of image capture 330. Based on a later image capture 330, readability monitor 112 observes the zone's readability index has increased above the threshold value based on the adjusted font size. If image capture 330 of the adjusted zone 319 does indicate an improvement of the readability index, then readability monitor 112 may revert the adjustment or attempt to adjust another display parameter for zone 317. For example, readability monitor 112 may continue to increase font size of text until the readability index is above the threshold value. In other scenarios, readability monitor 112 insert a blank space or limits applications from rendering in zone 317.

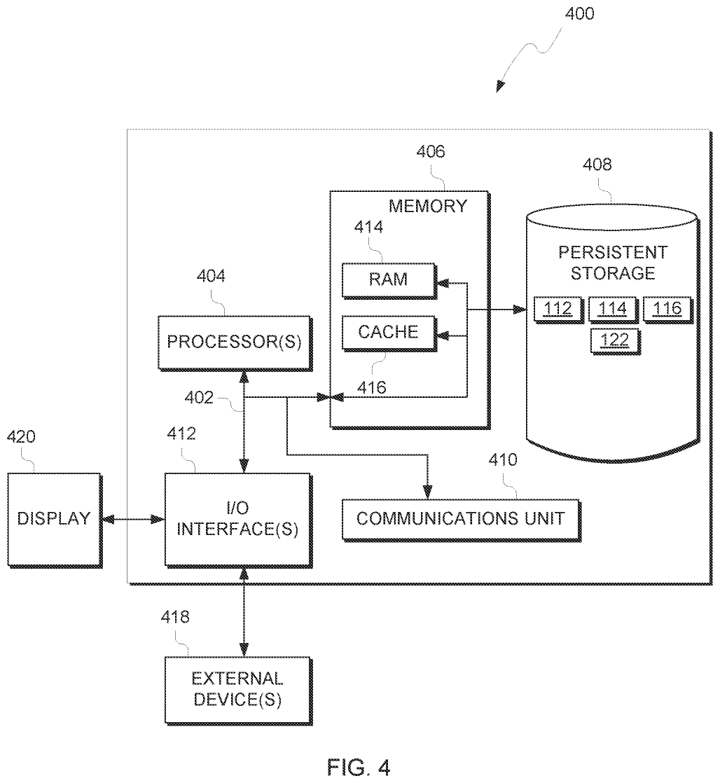

FIG. 4 depicts a block diagram, 400, of components of mobile device 110 and external device 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Mobile device 110 and external device 120 each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Readability monitor 112, view data 114, OCR data 116 and capture program 122 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 140. In these examples, communications unit 410 includes one or more network interface cards. Communications unit 410 may provide communications through the use of either or both physical and wireless communications links. Readability monitor 112, view data 114, OCR data 116 and capture program 122 may be downloaded to persistent storage 408 through communications unit 410.

I/O interface(s) 412 allows for input and output of data with other devices that may be connected to Mobile device 110 and external device 120. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., readability monitor 112, view data 114, OCR data 116 and capture program 122, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
retrieving, by one or more processors, an external capture of a display of a mobile device;
converting, by one or more processors, text in the external capture to a computer readable format;
determining, by the one or more processors, a readability index of the external capture based on a comparison of the text in the external capture to user-interface (UI) view data of the mobile device; and
in response to the readability index being below a threshold value, adjusting, by the one or more processors, at least one display parameter of a user interface of the mobile device.

2. The method of claim 1, wherein the least one display parameter includes one or more of the following: adjusting a font size of a UI, adjusting a zoom factor of the UI, adjusting a brightness of the display of the mobile device, or changing orientation of the display of the mobile device.

3. The method of claim 2, the method further comprising:
identifying, by the one or more processors, a plurality of zones in the display of the mobile device; and
in response to a zone readability index being below the threshold value, adjusting, by the one or more processors, at least one display parameter associated with a display area of the zone.

4. The method of claim 3, wherein at least one zone of the plurality of zones is associated with a non-flat portion of the display of the mobile device.

5. The method of claim 1, wherein the external capture is adjusted based on a viewing angle of an external device relative to the display of the mobile device.

6. The method of claim 1, wherein the UI view data includes text retrieved from an extensible markup language (XML) view tree of an application being rendered on the display of the mobile device at the time the external capture was taken.

7. The method of claim 1, wherein the UI view data also includes a current folding angle of the display of the mobile device at the time of external capture.

8. A computer program product comprising:
one or more computer-readable storage media and program instructions stored on the one or more computer-readable storage media, the program instructions comprising:
program instructions to retrieve an external capture of a display of a mobile device;
program instructions to convert text in the external capture to a computer readable format;
program instructions to determine a readability index of the external capture based on a comparison of the text in the external capture to user-interface (UI) view data of the mobile device; and
program instructions to, in response to the readability index being below a threshold value, adjust at least one display parameter of a user interface of the mobile device.

9. The computer program product of claim 8, wherein the least one display parameter includes one or more of the following: adjusting a font size of a UI, adjusting a zoom factor of the UI, adjusting a brightness of the display of the mobile device, or changing orientation of the display of the mobile device.

10. The computer program product of claim 9, the program instructions further comprising:
program instructions to identify a plurality of zones in the display of the mobile device; and
program instructions to, in response to a zone readability index being below the threshold value, adjust at least one display parameter associated with a display area of the zone.

11. The computer program product of claim 10, wherein at least one zone of the plurality of zones is associated with a non-flat portion of the display of the mobile device.

12. The computer program product of claim 8, wherein the external capture is adjusted based on a viewing angle of an external device relative to the display of the mobile device.

13. The computer program product of claim 8, wherein the UI view data includes text retrieved from an extensible markup language (XML) view tree of an application being rendered on the display of the mobile device at the time the external capture was taken.

14. The computer program product of claim 8, wherein the UI view data also includes a current folding angle of the display of the mobile device at the time of external capture.

15. A computer system comprising:
one or more computer processors;
one or more computer readable storage media; and
program instructions stored on the computer readable storage media for execution by at least one of the one or more processors, the program instructions comprising:
program instructions to retrieve an external capture of a display of a mobile device;
program instructions to convert text in the external capture to a computer readable format;
program instructions to determine a readability index of the external capture based on a comparison of the text in the external capture to user-interface (UI) view data of the mobile device; and
program instructions to, in response to the readability index being below a threshold value, adjust at least one display parameter of a user interface of the mobile device.

16. The computer system of claim 15, wherein the least one display parameter includes one or more of the following: adjusting a font size of a UI, adjusting a zoom factor of the UI, adjusting a brightness of the display of the mobile device, or changing orientation of the display of the mobile device.

17. The computer system of claim 16, the program instructions further comprising:
program instructions to identify a plurality of zones in the display of the mobile device; and
program instructions to, in response to a zone readability index being below the threshold value, adjust at least one display parameter associated with a display area of the zone.

18. The computer system of claim 17, wherein at least one zone of the plurality of zones is associated with a non-flat portion of the display of the mobile device.

19. The computer system of claim 15, wherein the external capture is adjusted based on a viewing angle of an external device relative to the display of the mobile device.

20. The computer system of claim 15, wherein the UI view data includes text retrieved from an extensible markup language (XML) view tree of an application being rendered on the display of the mobile device at the time the external capture was taken.
